(19) United States
(12) Patent Application Publication
(10) Pub. No.: US 2017/0161808 A1
(43) Pub. Date: Jun. 8, 2017

(54) Method and System for Automatic Generation of an Offer to Purchase a Valuable Object and Automated Transaction Completion

(71) Applicant: I Do Now I Don't, Inc., New York, NY (US)

(72) Inventor: Josh Opperman, New York, NY (US)

(73) Assignee: I Do Now I Don't, Inc., New York, NY (US)

(21) Appl. No.: 15/262,761

(22) Filed: Sep. 12, 2016

Related U.S. Application Data
(63) Continuation-in-part of application No. 13/929,629, filed on Jun. 27, 2013, now abandoned.
(60) Provisional application No. 61/837,592, filed on Jun. 20, 2013.

(51) Int. Cl. G06Q 30/06; G06K 9/62; G06Q 40/08; G06Q 30/02; G06Q 10/08

(52) U.S. Cl. CPC G06Q 30/0611; G06Q 30/0283; G06Q 30/0635; G06Q 10/0838; G06Q 40/08; G06K 9/6215

(57) ABSTRACT

This invention discloses a novel system and method for automatically determining the price to offer to purchase a valuable object, for example, jewelry or watches, and then an automated system to enter into a binding purchase agreement and to fulfill the purchase with an insured shipment of the object to the buyer.

### PRIORITY CLAIM

This application claims priority as a continuation-in-part of U.S. patent application Ser. No. 13/929,629, filed on Jun. 27, 2013, which is a non-provisional continuation of U.S. Provisional Application No. 61/837,592 filed on Jun. 20, 2013, both of which are herein incorporated by reference in their entireties.

### FIELD OF INVENTION

This invention provides a mechanism whereby a customer can automatically obtain a binding offer to purchase a piece of jewelry or a watch from a website and cause such website to automatically complete the purchase.

### BACKGROUND

Persons who possess valuable precious assets, for example, jewelry or watches, often seek to sell the assets for cash. Typically, the owner has to take the asset to a storefront where someone can examine the object and then make an offer to purchase it. This requires finding such a shop and further, trusting that the shop operating the storefront can make good on the purchase price. This is time consuming and involves a level of trust that may be absent in a small store-front. The invention claimed here is for a system that provides a website that permits the user to input aspects of the precious asset so that the system can automatically calculate an offer price. If the price is acceptable to the user, the website will automatically arrange for insured shipping of the asset and payment of the purchase price to the selling user. One aspect of the invention is how the website system automatically calculates a price for the precious asset being offered. Another aspect is how the system completes the transaction.

### DESCRIPTION OF THE FIGURES

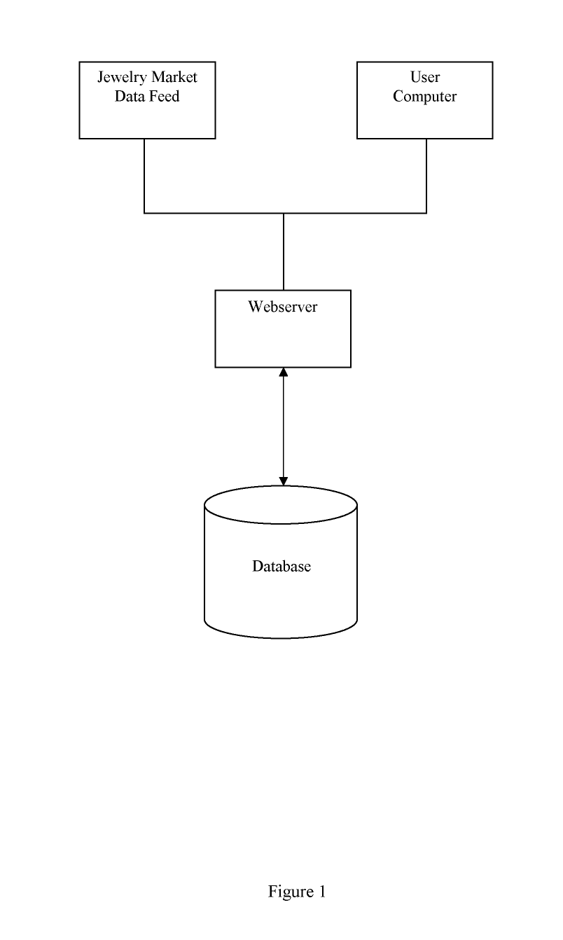

1. FIG. 1. Shows the Basic System Architecture

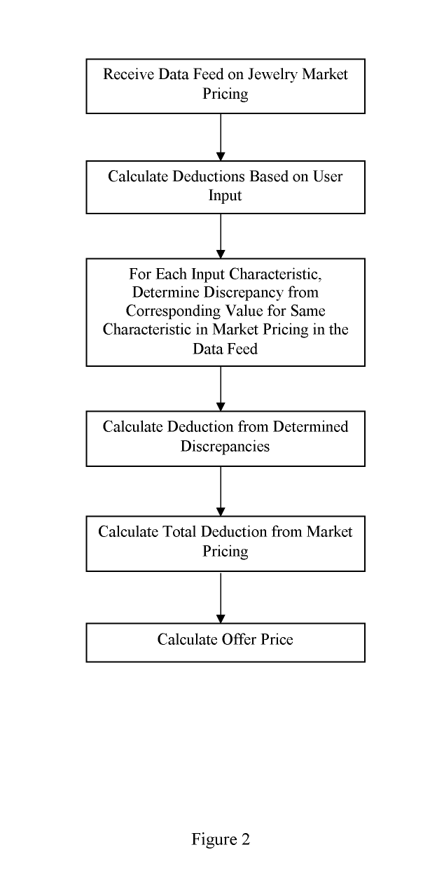

2. FIG. 2. Shows the Flow Chart for Price Calculation

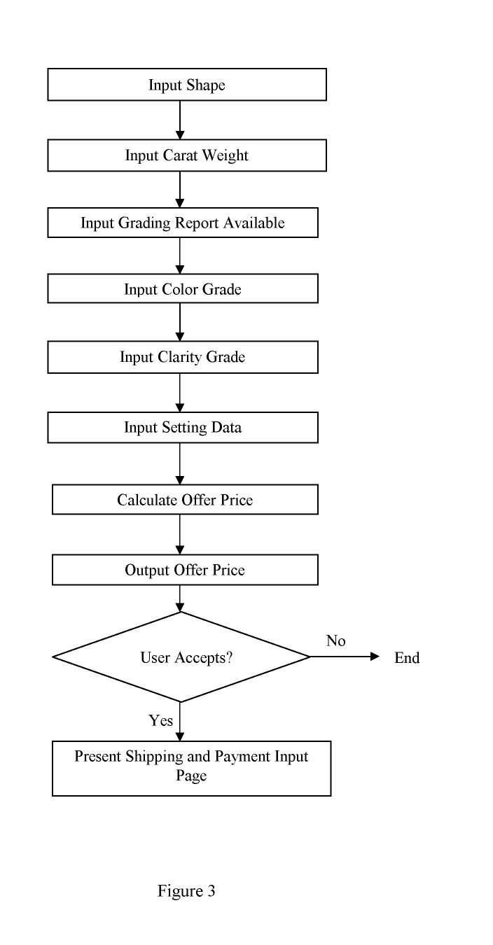

3. FIG. 3. Shows the Flow Chart for Data Acquisition for Gemstone Pricing

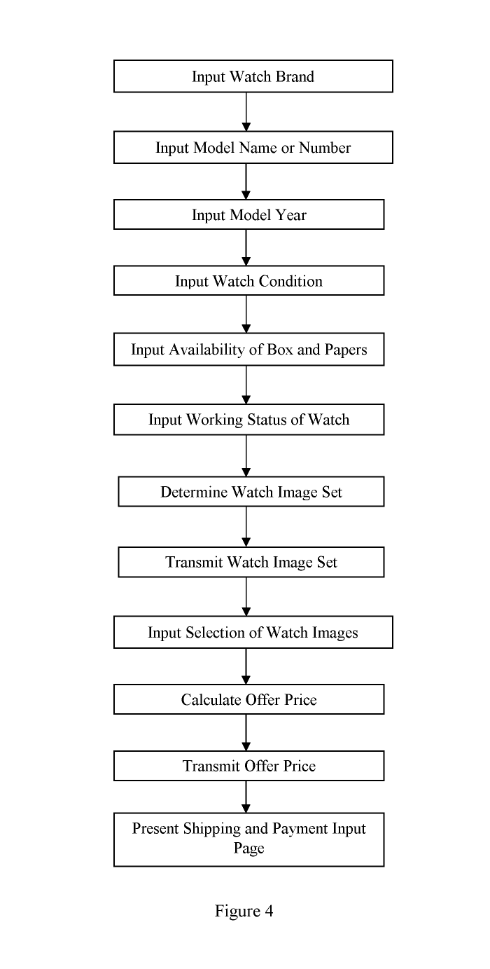

4. FIG. 4. Shows the Flow Chart for Data Acquisition for Watch Pricing

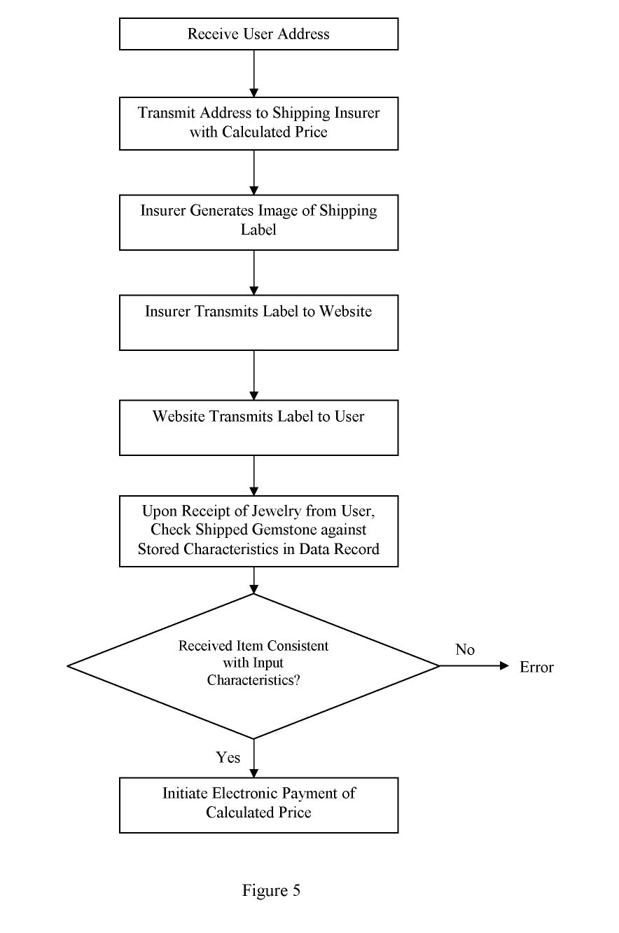

5. FIG. 5. Shows the Flow Chart for Transaction Processing.

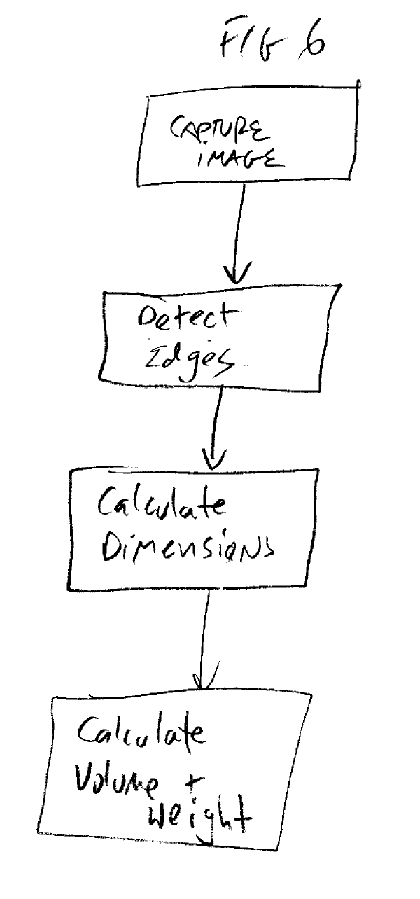

6. FIG. 6. Shows the Flowchart for calculating gemstone volume and weight

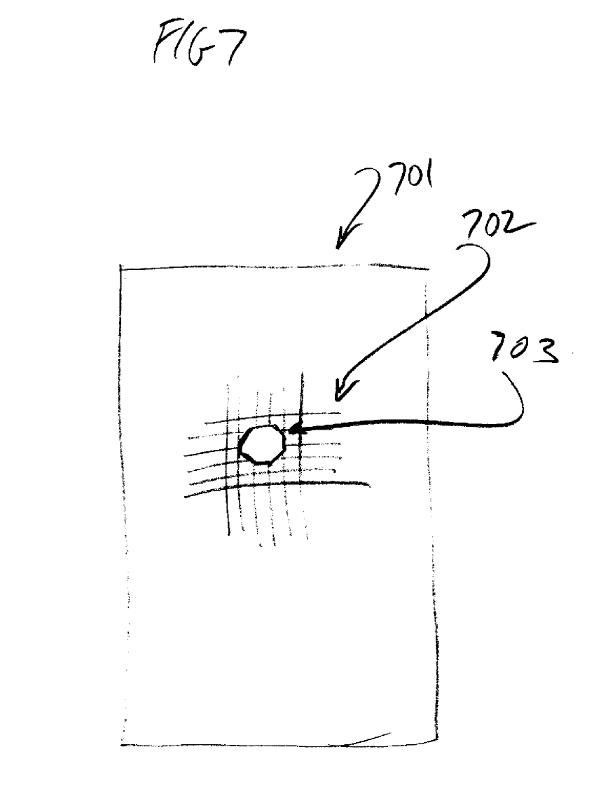

7. FIG. 7. Shows the Example reticle sheet with gemstone laying on it.

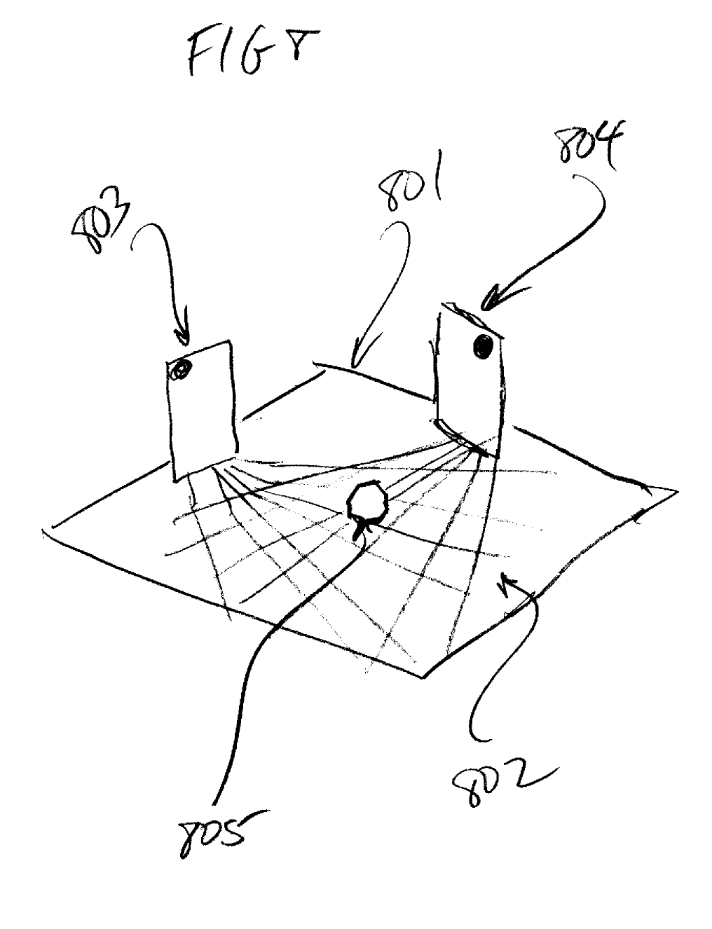

8. FIG. 8. Shows the Example reticle sheet with perspective lines for use in two image capture positions.

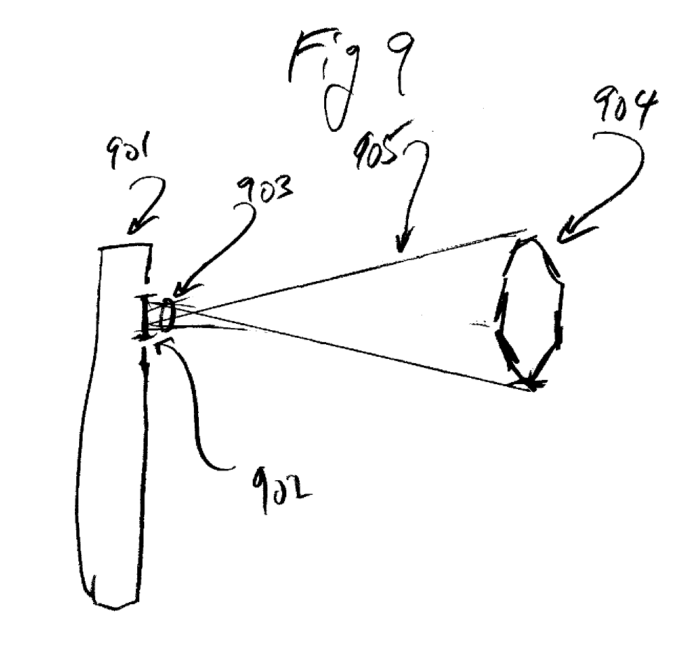

9. FIG. 9. Shows the Diagram showing triangle similarity for calculating gemstone size from image metadata and sensor size and pixel count.

### DETAILED DESCRIPTION OF THE PREFERRED EMBODIMENTS

The method and system operates on one or more computers, typically using a server and one or more remote user's computing devices. A customer's device can be a personal computer, mobile phone, mobile handheld device like a Blackberry™ or iPhone™ or a tablet device like the iPad™ or Galaxy™ or any other kind of computing device a user can use to view and edit an electronic document. In addition, the user device may have an image sensor, or camera, incorporated into the device. The user devices are operatively connected to the remote server using a data network. They typical user is someone who owns jewelry or a watch that they seek to sell. In one embodiment, the user accesses the system by means of an Internet browser software operating on their local computing device. The typical user establishes a user identifier with the system by inputting a user name and a password. This is used by the system for tracking the user's data. The browser interacts with the website server in order to provide a mechanism for the system to receive specific information about the jewelry or watch. In another embodiment directed to jewelry, the user operates a set of selection menus that display drawings of typical gemstone cuts and provides a selection mechanism that the user can actuate. By means of this user interface, the user can input characteristics of the gemstone, including: shape, carat weight, whether a grading report is available, color grade, clarity grade, and information about the setting. The system then stores this data into a data record that is associated with the user's identifier.

In yet another embodiment, the system relies on the user's remote device to take measurements of the gemstone. The typical user device is comprised of an image input component, for example, a digital camera. The user's device may operate a computer program that will use that image input device to capture an image of the gemstone. That image can contain data that permits the computer program to automatically calculate the volume of the gemstone and then use the identity of the gemstone, e.g. diamond, ruby, emerald, to select a density. Using the selected density value, the weight of the gemstone can be calculated. See FIG. 6.

In one embodiment, the circumference of the gemstone is measured. The image of the gemstone can provide a measurement by means of geometry. In one embodiment, the system can make available for download and printout a paper page (701) that has retical markings (702) in one or two dimensions. The user can then lay the gemstone (703) on the page and actuate the user interface on their device (901) to have the image captured. The computer program can then detect where the outline of the gemstone intersects with the reticle lines. By counting the intersections, in two dimensions, an x-y table of the locus of perimeter points can be created. From that x-y table, an area of a horizontal cross section of the stone can be calculated. The use of a reticle page can be used to place the camera at a known location relative to the gemstone. The camera resting at the correct location on the page, positioned vertically, (803) will detect the reticle lines (802) with a particular perspective distortion. That distortion will change depending on where the camera is located. Therefore, the computer program can, in real time, detect the reticle lines, and by comparing them to a standard expected projection of the lines, instruct the user how to move the mobile device with the image detection sensor until its location is properly confirmed. The reticle lines can be detected in the image by applying an edge detection algorithm to the image. At that point, when the computer program determines that the detected reticle lines match the expected lines, the camera can capture the image of the gemstone (805). In yet another embodiment, the computer program can call for two positions (803, 804) to be used to generate two images of the gemstone and thereby capture two perspectives of the gemstone dimensions. Given the known dimensions of the reticle and the known dimensions of the mobile device (and the location of the image sensor on that device), geometric calculations can determine the dimensions of the gemstone.

In another embodiment, the locations of facets can be detected by means of edge detection algorithms applied to the image. The layout of the detected facets may be used to approximate the shape and height of the gemstone. Each facet can be assumed to be a section of a convex three dimensional solid. Therefore, with the distance to the gemstone determined, the relative size of the facet edges in the image may be used to calculate the facet edge length. Given the circumference of the gemstone, and the measured facet edge lengths and angles, a volume may be calculated. The type of cut can inform the relative shape of the sizes to take into account spatial distortion from the angle of the facet relative to the camera. For example, if a gemstone as three facets going from one side to the other, of known length, the height of the stone may be determined by using a geometric calculation on the cross section, where the cross section is assumed to be a trapezoid of known perimeter, and known length of the base. The Pythagorean theorem may be used to calculate the height of the trapezoid. This may then be used with additional cross section calculations to obtain a calculation of the three dimensional volume of the stone.

In yet another embodiment, the metadata associated with the image and the sensor itself is exploited by the computer program to determine the size of the gemstone. In this embodiment, the computer has a table that matches the type of user device to a image sensor size in pixel by pixel basis and on the actual size. In addition, the table has for each type of device an entry for the focal length of the lens. For example, a camera on a mobile phone may have pixel resolutions of 3264×4480, a focal length of 4.10 mm and a sensor size of 4.54×3.42 mm. The size of the mobile device and the location on the device chassis of the image capture lens is also stored in the table. This information may be used to calculate the size on the sensor of the gemstone, and by using triangle similarity the size of the gemstone itself. For example, the mobile device (901) has a sensor (902) of known pixel dimension and size dimension for that mobile device model. The computer program can query the device itself to confirm the device type. The gemstone (904) is projected through lens (903) onto the surface of the sensor (902). Edge detection determines the size of the gemstone image on the sensor by using the pixel density on a per distance basis. The focal length may be used to calculate the relative size of the gemstone (904).

In yet another embodiment, the computer program may capture two or more images of the gemstone and use the two images to interpolate a three dimensional model of the object. In this case, the relative position of facet edges and vertices in the two images may be compared in order to determine the relative position of the camera and gemstone when each image was taken. Geometric calculations can be used to determine in three dimensions where the vertices and edges are. In one embodiment, the camera may be placed in motion, and using haptic or other motion sensors, for example, an accelerometer, at a known velocity. Then the camera can capture two images at two time intervals as the camera passes over the gemstone. The velocity and time interval will provide the distance between each camera position. That distance may be used to calculate the location of the vertices and edges detected in the image. In another embodiment, shown in FIG. 8, a reticle page may be used and the mobile device may capture two images of the gemstone. In yet another embodiment of the invention, the distance from the mobile device to the gemstone may be determined by using an audio signal. The computer program can actuate an audible chirp and detect its reflection from a table surface. The distance is calculated using the assumed speed of sound. Alternatively, a motion picture can be used in combination with an accelerometer to use dead reckoning to calculate the position of the gemstone relative to the camera. In this embodiment, the camera rests on the table with the gemstone, and is then lifted up from the table. The computer program then uses the accelerometer data to determine for each frame in the video, the height of the camera. The computer program selects the frame to use as the image for further processing based on the best image size of the gemstone in combination with the longest distance value to reduce errors in the calculatinos. Two or more of the above methodologies may be combined in whole or in part to further improve the calculation of the volume of the gemstone.

In yet another embodiment, the relative quality of the gemstone can be determined by use of the flash lighting on the user's device. The system can have a table or numerical model that specifies the expected light spectrum and intensity for a flash image of a gemstone of a particular size and quality level. For example, a blue hued diamond may exhibit more blue light in the reflected light comprising the light entering the sensor in order to form the image, as compared to a yellow hued diamond. In this embodiment, the computer program uses the color components in the pixel data to form a histogram of relative primary color intensity within the image. These relative differences can be compared to a standard to determine if the gemstone is within a margin of error of one type of diamond or the other. The same technique may be used with other gemstones as well.

The methodologies and computer functions for calculating the size of the gemstone or its relative color can reside either in the remote device or on the server. In the former case, the computer program that executes the calculations operates on the user's device and transmits finished dimensions to the server. In the latter case, the user's device transmits the image or images to the server and the server calculates the dimensions and thereby the weights and values.

In another embodiment, the user is prompted for information about the watch they seek to sell. In this case, the user interface obtains information from the user including: watch brand, model number, model year, condition, availability of box or certification papers, working status. The system uses some or all of this information to search in a database to recover a set of at least one images of watches that are determined to be candidates for the identity of the user's watch. These images are transmitted to the user's computer device and displayed on the computer's screen. The user interface presented by the browser then takes as input a selection by the user of one of the images that most closely matches the user's watch. The system then stores all of this input data into a data record that is associated with the user's identifier.

In yet another embodiment, the system is designed to use image recognition to determine the type of watch subject to the sale offer. In this embodiment, the user interface permits the user to input an image file that is a picture of the watch. Alternatively, an email address may be provided that is associated with the transaction and the person can use a portable device that has a digital camera and email capability to photograph the watch and transmit the image to the system. The system database would contain data records that are comprised of watch images, which are associated with other data, for example, the manufacturer, model and model year. The data record may also have data representing image features extracted from the image that can be used for automated image matching. In this embodiment the received image is processed to extract particular features from the image that can be used to search the database of watch images to find the closest matching images. These close matches will be used to select actual images that are transmitted to the user's browser for presentation. The user can then confirm which watch is the exact match. In another embodiment, the system relies on its best match determination. In this manner, the watch brand, model and model year is obtained without the user having to manually input all of the watch brand, model and model year particulars.

When the user has input the jewelry characteristics in the system, the system can then calculate the offer price. This is accomplished by the system monitoring data that it receives from one or more gemstone trading markets that distribute trade pricing electronically. In one embodiment, the market data is for diamonds and the market rates for diamond trading from the Rap Report™. In this embodiment, the system inspects the market pricing data to locate a gemstone price that most closely matches the gemstone input by the user. However, the market pricing data may be for a gemstone of higher or lower quality than the user's gemstone. The system then obtains a set of predetermined price adjustment factors that correspond to each characteristic that is different about the user's gemstone as compared to the gemstone called out in the market data.

For example, a high value diamond whose trade price is called out in the data may be of the same weight as the user's diamond, but the color of the market diamond may be blue while the user's diamond is yellow. The system them obtains from its database a predetermined discount factor that corresponds to a discrepancy in color from blue to yellow. All of the discount adjustments are determined by comparing all of the characteristics. An offer price can then be calculated by applying the entire set of discounts to the market price value. This can be done by calculating a series of factors: the market price is multiplied by all of the discounts to arrive at the offer price. In the typical embodiment for diamonds, the market pricing report will provide an exact match for an input or color, clarity, cut, shape and weight of a diamond. The deductions will apply for characteristics of type of certificate, cut grade, fluorescence, type of gold in setting, and brand source of the jewel. Once the offer price is calculated by the system, the system transmits the offer price to the user's computer for display on the browser.

In the embodiment of the invention applied to valuable watches, the system obtains data feeds from on-line market places that offer used watches for sales. In one embodiment, two API feeds interface the system to market places available on Amazon™ and Google™. In this embodiment, characteristics of the user's watch are used to scan for similar watches with offered or quoted prices. In the preferred embodiment, special deduction rules are applied to certain brands, that is, the deduction for watch condition may be different for a Rolex™ as compared to another brand of watch. In this embodiment, the system database has a matrix for the deduction factors, where the rows are for the characteristic type and column for the applicable brand. In another dimension can be the amount of discrepancy with individual entries for each factor in that case. As with the jewelry price calculator, the offer price for the watch is calculated by multiplying the discount factors times the market price detected from the market data feeds.

In one embodiment, the data input by the user is used to determine a vector, whose elements are pairs of numbers, one being a reference to a type of attribute and the other to the amount of discount. The vector is then stored in a database associated with the transaction. The data associated with the nearest matching gemstone in the market data feed can be used to create a vector for that market point. The two vectors can be subtracted on an element by element basis. Where the attributes are the same, there is a zero for the result vector element. In the other position, a difference is held. A third vector is created that is the set of discount factors corresponding to the types of attributes. This discount vector is then vector multiplied with the result vector as described below to calculate a single discount number to apply to the market price of the market gemstone. Where the difference elements are zero, no discount component applies, so the discount for that element is zero. Where the difference elements are non-zero, the discount factor for that element gets multiplied by the difference in the attribute value to obtain a discount for that element. When all of the discount elements for the individual attributes are calculated, the non-zero discount elements are multiplied to arrive at a single discount that applies to the entire price.

The system transmits the offer price for the jewelry or watch to the user after it is calculated. The user interface then permits the user to actuate buttons that encode whether the user accepts or rejects the offer. The browser transmits this encoded response to the central servers comprising the system. The system causes the browser to display input boxes in order that the user input their name and address, email address and any other information necessary to complete the transaction. This may also include the form of payment the seller seeks, and any relevant account data necessary to effectuate electronic payment of the purchase price. The system also transmits for display a click-through agreement to the user that expresses the purchase agreement to sell the jewelry or watch. If the user clicks an “ACCEPT” button, then this is stored in the data record. In another embodiment, the user takes a picture of the jewelry and transmits it to an email address portal that is specific to this transaction. The system then receives the image file and then stores it in the database in a record associated with the user identifier.

Once a purchase agreement has been entered into electronically, and shipping information provided by the user, the purchase transaction then moves to automated fulfillment. In this case, the system transmits the relevant user information to a third party system operated by a party that provides insurance for the shipping of the jewelry or watch. The transmitted information may include the name and address of the seller, the relevant information about the jewelry or watch and the amount of the offer price. The third party system can then procure insurance for the shipment and generate a shipping label for the shipment that includes the destination address of the entity actually buying the jewelry or watch. This is an image that can be printed out on a computer printer and used by typical courier services that ship small objects. The shipping label image is transmitted to the system, which then transmits it on to the user's computer, either as an email attachment or through the browser providing a hyperlink to the document. The user can then print the label and use it to ship the jewelry or watch to the buyer operating the system. In one embodiment, the insuring system is operated by Parcel Pro™. The automatic purchasing system invention accesses this third party's systems through an API in order to fetch a Fed Ex™ shipping label, which is then transmitted to the selling user as an email attachment. As soon as the request for a shipping label is submitted, an amount for an insurance premium determined and the insurance is associated with the serial number of the shipping label. When the shipping label is used, that is, when it is scanned by Fed Ex™ personnel accepting the package for shipment, Fed Ex™ transmits notice to Parcel Pro™ who then charges the buyer the insurance premium.

When the package arrives from the seller, the package is opened and inspected. A person operating a computer accesses the system database and inputs the shipping label number. This brings up the purchase transaction information. The person can then inspect the jewelry or watch and check whether the unit in hand matches what was purported to be subject to the sale transaction as described by the data in the database. If there is a sufficient match, then the person can click an acceptance button on the user interface. This causes the system to automatically process payment to the selling user, through any kind of electronic payment mechanism, including credit card, PayPal™, ACH or other techniques.

In yet another embodiment, the system calculates the binding offer price, as provided above. However, the pricing history data may be used to calculate a second estimate of market value. The system transmits to the user data representing both estimates so that the user's device displays them. The user interface on the user's device has at least two input choices where the user can either select the binding offer price or the second estimate. If the user actuates the user interface in order to select the binding offer, then the system operates as provided above in order to fulfill the purchase. If the user actuates the user interface in order to select the second estimate, the information that the user submitted describing the gemstone or watch is transmitted to another server in order that their valuable asset is listed for sale, with that second estimate as the offer price.

Operating Environment:

The user's computer may be a laptop, desktop type of personal computer. It can also be a cell phone, smart phone or other handheld device, including a tablet. The precise form factor of the user's computer does not limit the claimed invention. Examples of well known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

The system and method described herein can be executed using a computer system, generally comprised of a central processing unit (CPU) that is operatively connected to a memory device, data input and output circuitry (I/O) and computer data network communication circuitry. A video display device may be operatively connected through the I/O circuitry to the CPU. Components that are operatively connected to the CPU using the I/O circuitry include microphones, for digitally recording sound, and video camera, for digitally recording images or video. Audio and video may be recorded simultaneously as an audio visual recording. The I/O circuitry can also be operatively connected to an audio loudspeaker in order to render digital audio data into audible sound. Audio and video may be rendered through the loudspeaker and display device separately or in combination. Computer code executed by the CPU can take data received by the data communication circuitry and store it in the memory device. In addition, the CPU can take data from the I/O circuitry and store it in the memory device. Further, the CPU can take data from a memory device and output it through the I/O circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory.

The computer can display on the display screen operatively connected to the I/O circuitry the appearance of a user interface. Various shapes, text and other graphical forms are displayed on the screen as a result of the computer generating data that causes the pixels comprising the display screen to take on various colors and shades. The user interface also displays a graphical object referred to in the art as a cursor. The object's location on the display indicates to the user a selection of another object on the screen. The cursor may be moved by the user by means of another device connected by I/O circuitry to the computer. This device detects certain physical motions of the user, for example, the position of the hand on a flat surface or the position of a finger on a flat surface. Such devices may be referred to in the art as a mouse or a track pad. In some embodiments, the display screen itself can act as a trackpad by sensing the presence and position of one or more fingers on the surface of the display screen. When the cursor is located over a graphical object that appears to be a button or switch, the user can actuate the button or switch by engaging a physical switch on the mouse or trackpad or computer device or tapping the trackpad or touch sensitive display. When the computer detects that the physical switch has been engaged (or that the tapping of the track pad or touch sensitive screen has occurred), it takes the apparent location of the cursor (or in the case of a touch sensitive screen, the detected position of the finger) on the screen and executes the process associated with that location. As an example, not intended to limit the breadth of the disclosed invention, a graphical object that appears to be a 2 dimensional box with the word “enter” within it may be displayed on the screen. If the computer detects that the switch has been engaged while the cursor location (or finger location for a touch sensitive screen) was within the boundaries of a graphical object, for example, the displayed box, the computer will execute the process associated with the “enter” command. In this way, graphical objects on the screen create a user interface that permits the user to control the processes operating on the computer.

The system is typically comprised of a central server that is connected by a data network to a user's computer. The central server may be comprised of one or more computers connected to one or more mass storage devices. The precise architecture of the central server does not limit the claimed invention. In addition, the data network may operate with several levels, such that the user's computer is connected through a fire wall to one server, which routes communications to another server that executes the disclosed methods. The precise details of the data network architecture does not limit the claimed invention.

A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In addition, the access of the website can be by means of an Internet browser accessing a secure or public page or by means of a client program running on a local computer that is connected over a computer network to the server. A data message and data upload or download can be delivered over the Internet using typical protocols, including TCP/IP, HTTP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application.

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The invention may be described in the general context of computer-executable instructions, such as program modules, being executed by a computer. Generally, program modules include routines, programs, objects, components, data structures, etc., that perform particular tasks or implement particular abstract data types. The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.) It is appreciated that any of the software components of the present invention may, if desired, be implemented in ROM (read-only memory) form. The software components may, generally, be implemented in hardware, if desired, using conventional techniques.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the specification is intended only to provide an extremely detailed disclosure of the present invention and is not intended to be limiting.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention, as defined by the following claims.

What is claimed:

1. A system comprised of a computer operatively connected to a first database for automatically conducting a purchase of a valuable object comprising:
a module comprised of an image sensor adapted by logic to capture as data an image of the valuable object;
a module adapted by logic to automatically calculate using the captured image data at least one dimension of the valuable object;
a module adapted by logic to automatically calculate the volume and weight of the valuable object using the at least one calculated dimensions and a predetermined density value associated with the valuable object;
an input module adapted to receive from a remote computer input data describing the at least one physical characteristics of the valuable object;
the first database being adapted to periodically and automatically receive and store pricing data for at least one objects similar to the valuable object, said pricing data comprised of at least one trade price value corresponding to the at least one similar objects, data describing physical characteristics corresponding to the at least one similar objects, said database being further comprised of at least one discount factor corresponding to at least one physical characteristic;
said database further adapted to store a data record associated with the valuable object, said data record comprised of data representing at least one physical characteristics of the valuable object; and
a price calculating module adapted to automatically calculate an offer price value corresponding to the valuable object using the data comprising the data record, the stored pricing data and at least one stored discount factor.

2. The system of claim 1 further comprising:
A fulfillment module adapted to automatically procure an insurance contract for shipment of the valuable object by transmitting to a second database the calculated price and at least one of the physical characteristics corresponding to the valuable object, receiving data representing a shipping label for the shipment and transmitting the data representing the shipping label to the remote computer.

3. The system of claim 1 where the valuable object is comprised of a gemstone.

4. The system of claim 1 where the valuable object is comprised of a watch.

5. The system of claim 1 where the price calculating module is further adapted to:
select a trade price from the first database in dependence on at least one of the characteristics comprising the data record associated with the valuable object;
determine which physical characteristics of the valuable object are different from the physical characteristics associated with the selected trade price;
in dependence on such determination of the differing characteristics, receive from the first database at least one discount factors corresponding to the determined differing characteristics;
automatically calculate the offer price value by using the at least one received discount factors and the selected trade price;
store the calculated offer price value in the data record associated with the valuable object; and
transmit the calculated offer price value to the remote computer.

8. The system of claim 4 where the input module is adapted to receive from the remote computer a data file representing an image of the watch and the first database is further adapted to be comprised of at least one data record associated with a specific watch, said watch having a watch brand and watch model year, said data record further comprised of an image file representing a picture of the watch, where the first database uses the received image to locate one of the data records associated with a specific watch by means of matching the received image with the image file associated with the specific watch in order to automatically determine at least one of the brand, model and model year of the watch associated with the received image.

9. The system of claim 7 where the system is further adapted to:
automatically calculate the offer price value by multiplying one received discount factor times the trade price value.

10. The system of claim 4 where the price calculating module is further adapted to:
select a trade price from the first database in dependence on at least one of the physical characteristics comprising the data record associated with the valuable object;
determine which physical characteristics of the valuable object are different from the physical characteristics associated with the selected trade price;
in dependence on such determination of the differing characteristics, receive from the first database at least one discount factors;
automatically calculate the offer price value by using the at least one received discount factors and the selected trade price;
store the calculated offer price value in the data record associated with the valuable object; and
transmit the calculated offer price value to the remote computer.

11. The system of claim 7 where the physical characteristic is a gemstone shape.

12. The system of claim 7 where the physical characteristic is a gemstone carat weight.

13. The system of claim 7 where the physical characteristic is the availability of a gemstone grading report.

14. The system of claim 7 where the physical characteristic is a gemstone clarity grade.

15. The system of claim 7 where the physical characteristic is the gemstone's setting.

16. The system of claim 10 where the physical characteristic is the watch brand.

17. The system of claim 10 where the physical characteristic the watch model number.

18. The system of claim 10 where the physical characteristic is the watch model year.

19. The system of claim 10 where the physical characteristic is the watch condition.

20. The system of claim 10 where the physical characteristic is the availability of a box or certification papers.

21. The system of claim 10 where the physical characteristic is the watch working status.

22. The system of claim 7 further comprising:
A fulfillment module adapted to automatically procure an insurance contract for shipment of the valuable object by transmitting to a second database the calculated offer price and at least one of the characteristics corresponding to the valuable object, receiving data representing a shipping label for the shipment and transmitting the data representing the shipping label to the remote computer.
